(19) United States
(12) Patent Application Publication
(10) Pub. No.: US 2026/0336969 A1
(43) Pub. Date: Oct. 29, 2026

(54) CONTROL METHOD AND APPARATUS FOR LIFT BRAKING

(71) Applicant: Otis Elevator Company, Farmington, CT (US)

(72) Inventor: Guosong Li, Tianjin (CN)

(21) Appl. No.: 19/408,976

(22) Filed: Dec. 4, 2025

(30) Foreign Application Priority Data
Apr. 28, 2025 (CN) 202510549941.9

(51) Int. Cl. B66B 1/32

(52) U.S. Cl. CPC B66B 1/32

(57) ABSTRACT

An elevator brake control method and device, a non-transitory computer-readable storage medium storing computer programs/instructions for implementing the method. In a control method for elevator braking, a brake holding current is determined based on an actual load and a travel direction of the elevator car. In cases where the actual load is relatively small or the elevator car is travelling upward, a larger brake holding current can be set. On the other hand, in cases where the actual load is relatively large or the elevator car is travelling downward, a smaller brake holding current can be set. Subsequently, a brake power supply provides the determined brake holding current to a brake coil, and the connection between the brake coil and the brake power supply is severed when an event triggering an emergency stop operation occurs.

### FOREIGN PRIORITY

This application claims priority to Chinese Patent Application No. 202510549941.9, filed Apr. 28, 2025, and all the benefits accruing therefrom under 35 U.S.C. § 119, the contents of which in its entirety are herein incorporated by reference.

### TECHNICAL FIELD

The present disclosure relates to an elevator technology, and in particular to a control method and device for elevator braking, a non-transitory computer-readable storage medium storing computer programs/instructions for implementing the method, and a computer program product comprising computer programs/instructions for implementing the method.

### BACKGROUND

The emergency stop of an elevator system commonly refers to a safety mechanism that immediately halts an elevator's operation and keeps it in a brake state by triggering an emergency stop device or a safety protection function. An elevator brake or a holding brake is a key component providing the safety protection function. It supplies the necessary braking force during an emergency stop to ensure an elevator car stops moving promptly. However, an excessively large braking force during an emergency stop will cause the elevator car to decelerate too quickly, resulting in discomfort for passengers and even causing physical harm to vulnerable groups (such as pregnant women, elderly people, children, and others).

### SUMMARY

In a control method for elevator braking according to one aspect of the present disclosure, a brake holding current is determined based on an actual load and a travel direction of an elevator car. In cases where the actual load is relatively small or the elevator car is travelling upward, a larger brake holding current can be set. On the other hand, in cases where the actual load is relatively large or the elevator car is travelling downward, a smaller brake holding current can be set. Subsequently, a brake power supply provides the determined brake holding current to a brake coil, and the connection between the brake coil and the brake power supply is severed when an event triggering an emergency stop operation occurs.

In a control device for elevator braking according to another aspect of the present disclosure, the computer programs/instructions stored on a memory, when executed on a processor, will cause the following operations: determining a brake holding current based on an actual load and a travel direction of an elevator car; enabling a brake power supply to provide the determined brake holding current to a brake coil; and in response to an event triggering an emergency stop operation, severing the connection between the brake coil and the brake power supply. Especially in cases where the actual load is relatively small or the elevator car is travelling upward, a larger brake holding current can be set. On the other hand, in cases where the actual load is relatively large or the elevator car is travelling downward, a smaller brake holding current can be set.

According to still another aspect of the present disclosure, there is provided a computer-readable storage medium with computer programs/instructions stored thereon suitable for execution by a processor of a terminal device, and the execution of the computer programs/instructions causes the steps of the method described above to be performed.

According to a further aspect of the present disclosure, there is provided a computer program product comprising computer programs/instructions, and the execution of the computer programs/instructions causes the steps of the method described above to be performed.

### BRIEF DESCRIPTION OF THE DRAWINGS

The above and/or other aspects and advantages of the present disclosure will become clearer and easier to understand in conjunction with the following description in various aspects of the drawings. The same or similar units in the drawings are represented by the same reference numerals. The drawings include:

FIG. 1 shows an exemplary view of an elevator system.

FIG. 2 schematically illustrates an elevator system with a safety protection function.

FIG. 3 shows an electrical schematic diagram of a device that can provide a safety protection function.

FIG. 4 shows a flowchart of a control method for elevator braking according to one embodiment of the present disclosure.

FIG. 5 shows a flowchart of a control method for elevator braking according to another embodiment of the present disclosure.

FIG. 6 shows a schematic block diagram of a control device for elevator braking according to yet another embodiment of the present disclosure.

### DETAILED DESCRIPTION OF THE INVENTION

The present disclosure will be more fully described hereinafter with reference to the drawings of the exemplary embodiments of the present disclosure. However, the present disclosure may be implemented in different forms, and should not be construed as being limited only by the various embodiments provided herein. The various embodiments aim to make the present disclosure more comprehensive and complete, so that the protection scope of the present disclosure would be more fully conveyed to a person skilled in the art.

In this specification, the terms such as “comprise” and “include” indicate that in addition to the units and steps directly and explicitly stated in the specification and claims, the technical solution of the present disclosure also does not exclude the circumstances where there are other units and steps that are not directly or explicitly stated.

Unless specifically stated, the terms such as “first” and “second” do not indicate the sequence of the units in terms of time, space, size, and the like, but are merely used to distinguish various units.

It will be understood that the expressions such as “connecting” or “coupling” one component to another component include the circumstances where the component is directly connected to another component, and also include the circumstances where the component is connected to another component by an intermediate component.

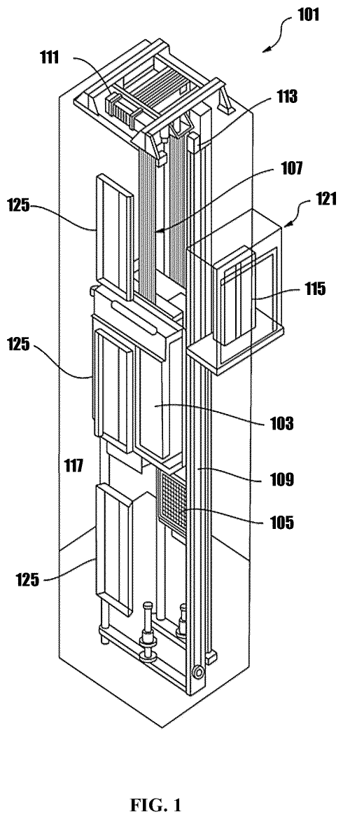

FIG. 1 shows an exemplary view of an elevator system. The elevator system 101 illustrated in FIG. 1 includes an elevator car 103, a counterweight 105, a tension member 107, a guide rail (or rail system) 109, a unit (or unit system) 111, a position reference system 113 and an electronic elevator controller (controller) 115. The elevator car 103 and the counterweight 105 may be coupled to each other by the tension member 107. The tension member 107 may include or be configured as, for example, a rope, a steel cable and/or a coated steel strip. The counterweight 105 is configured to balance the load of the elevator car 103, and is configured to facilitate moving the elevator car 103 within the elevator shaft (or hoistway) 117 and along the guide rail 109 relative to the counterweight 105 in the opposite direction and simultaneously.

The tension member 107 may be coupled to the unit 111 which may form part of the overhead structure of the elevator system 101. The unit 111 is configured to control movement between the elevator car 103 and the counterweight 105. The position reference system 113 may be installed on a fixed portion at the top of the elevator shaft 117, for example, on a support member or guide rail, and may be configured to provide position signals regarding the position of the elevator car 103 in the elevator shaft 117. In other embodiments, the position reference system 113 may be installed directly on a mobile component of the unit 111, or may be located in other positions and/or configurations known in the art. The position reference system 113 may be any device or mechanism known in the art for monitoring the position of the elevator car and/or the counterweight. As may be understood by a person skilled in the art, the position reference system 113, for example, includes but is not limited to encoders, sensors or other systems, and may perform various sensing such as velocity sensing, absolute position sensing and the like.

As shown therein, the controller 115 is located in a control room 121 of the elevator shaft 117, and is configured to control the operation of the elevator system 101 (and in particular, the elevator car 103). For example, the controller 115 may send drive signals to the unit 111 to control acceleration, deceleration, levelling, stopping etc. of the elevator car 103. The controller 115 may also be configured to receive position signals from the position reference system 113 or any other desirable position reference device. When moving up or down along the guide rail 109 within the elevator shaft 117, the elevator car 103 may stop at one or more landings 125 as controlled by the controller 115. In spite of being illustrated in the control room 121, a person skilled in the art will appreciate that the controller 115 may be located and/or configured in other places or positions within the elevator system 101. In one embodiment, the controller may be remotely located or positioned in the cloud.

The unit 111 may include a motor or a similar driving mechanism. According to the embodiments of the present disclosure, the unit 111 is configured to include an electrically driven motor. The power supply of the motor may be any power source, including a power grid, and the power source in combination with other components are supplied to the motor. The unit 111 may include traction sheaves which impart a force to the tension member 107 so as to move the elevator car 103 within the elevator shaft 117.

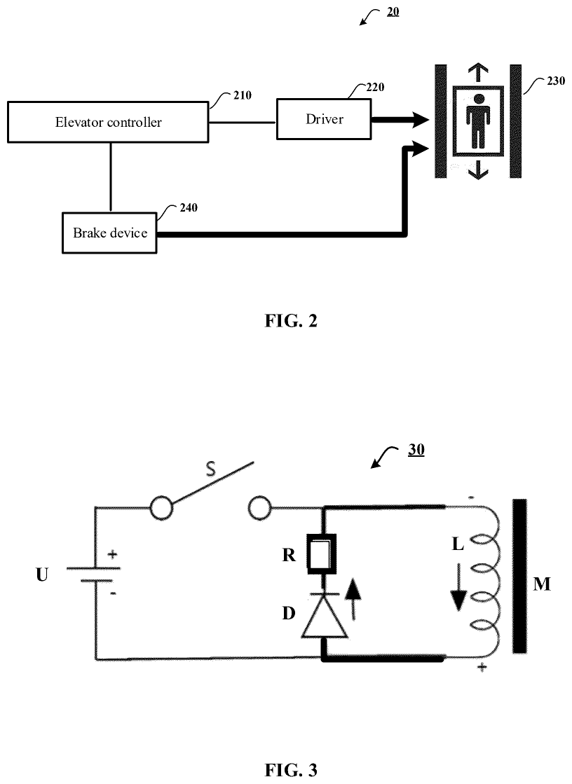

FIG. 2 schematically illustrates an elevator system with a safety protection function. As illustrated in FIG. 2, the elevator system 20 comprises an elevator controller or a main control unit 210 (such as the controller 115 in FIG. 1), a driver 220 (such as the unit 111 in FIG. 1), an elevator car 230, and a brake device 240. Based on a control command of the elevator controller 210, the driver 220 controls the relative movement between the elevator car 230 and the counterweight, so that the elevator car 230 can stop at the desired floor.

Exemplarily, the elevator controller 210 illustrated in FIG. 2 is also integrated with a safety protection function. In a normally operating elevator system, under the control of the elevator controller 210, when the elevator car 340 stops at a landing door, the brake power supply of the brake device 240 stops supplying power to the brake coil. This causes the brake shoes to clamp the brake wheel, holding the elevator car 230 stationary at its current position. During the movement of the elevator car 230, by supplying power from the brake power supply of the brake device 240 to the brake coil to drive the brake arm, the brake shoes are completely disengaged from the brake wheel. In addition, when an event triggering an emergency stop operation occurs, under the control of the elevator controller 210, the brake device 210 will quickly enter the engaged state or brake state.

Examples of the event triggering an emergency stop operation include, but are not limited to, pressing the emergency stop button, disconnection of safety circuits (the disconnection may be triggered by any one of the safety devices such as door lock circuits, overspeed governor switches, safety gear activation switches, buffer switches, etc.), control system failures (such as motor runaway, abnormal brake feedback, loss of position signals, etc.), and occurrence of external events (such as power outage of emergency power supplies like UPS).

It should be noted that, in the elevator system illustrated in FIG. 2, the braking operation is mainly controlled by the elevator controller. However, this means of implementation is not necessary. In some other exemplary elevator systems, a control device or safety controller independent from the elevator controller can be used to control the brake device.

FIG. 3 shows an electrical schematic diagram of a device that can provide a safety protection function. This device can be used to implement the brake device illustrated in FIG. 2. The device illustrated in FIG. 3 comprises a brake power supply U, a switching element S, a resistor R, a flyback diode D, and a brake coil L. Referring to FIG. 3, the brake power supply U is connected in series with the switching element S and the brake coil L to form a main loop. When the switching element S is closed, a current flows out from the positive electrode of the brake power supply U, flows into the brake coil L through the switching element S, and then returns to the negative electrode of the brake power supply U. At this time, the electromagnetic energy is stored in the brake coil L. On the other hand, the flyback diode D and the resistor R are connected in series and then connected in parallel across both ends of the brake coil L, with the polarity of the flyback diode D opposite to the voltage polarity when the brake coil L is normally energized (i.e., connected in anti-parallel). When the switching element S is disconnected, the induced electromotive force generated by the brake coil L causes the flyback diode D to conduct forward, thereby providing a freewheeling path for the coil current. At this time, the electromagnetic energy stored in the brake coil L is dissipated.

In the device 30 illustrated in FIG. 3, when there is a current flowing through the brake coil L, a strong magnetic field is generated in the iron core M, thereby attracting the armature. The armature drives the brake shoes to disengage from the brake wheel via the brake arm. Conversely, when no current flows through the brake coil L, the magnetic field disappears, the iron core loses attraction, and the brake spring pushes the armature away from the iron core, thereby causing the brake shoes to press firmly against the brake wheel through the brake arm.

Exemplarily, the switching element S is an N-type or P-type metal-oxide-semiconductor field-effect transistor (MOSFET). It should be noted that other types of electronic switches may also serve as the switching element, for example, including but not limited to an insulated gate bipolar transistor (IGBT) and a gate turn-off thyristor (GTO). By applying an enable signal (such as a high-level signal for an N-type MOSFET or a low-level signal for a P-type MOSFET) at the control end of the switching element S (such as the gate electrode of the MOSFET), the switching element S can be in a conducting state. On the other hand, by applying a disable signal (such as a low-level signal for an N-type MOSFET or a high-level signal for a P-type MOSFET) to the control end, the switching element S can be in the off state. In this specification, various forms of enable signals and disable signals are collectively referred to as control signals for the switching element.

It should be noted that when the brake shoes are already or almost completely disengaged from the brake wheel, even if the current flowing through the brake coil is reduced from a higher level to a lower level, it can still be ensured that the brake shoes are disengaged from the brake wheel. The aforementioned higher-level current and lower-level current are hereinafter referred to as a pick-up current and a brake holding current, respectively. By applying a pulse width modulation (PWM) signal with a different duty cycle to the control end of the switching element as an enable signal, it is possible to adjust the magnitude of the brake holding current.

It should also be noted that, the electrical schematic diagram as illustrated is merely exemplary. After reading this specification, a person skilled in the art will recognize that the disclosed content is also applicable to other devices that provide a braking function by controlling the brake holding current.

In some embodiments of the present disclosure, the aforementioned brake holding current varies with the state of the elevator system (such as the actual load and travel direction of the elevator car) to avoid or mitigate too rapid deceleration of the elevator car on the premise of providing sufficient braking capability, thereby improving user experience and reducing wear on the braking components. In such a self-adaptive control method, in terms of the relationship between the actual load of the elevator car and the brake holding current, when the actual load is relatively small, a smaller braking force is sufficient to achieve the desired deceleration level of the elevator car. Therefore, the brake holding current is set higher so that it decays more slowly or the braking torque increases at a slower rate. On the other hand, when the actual load is relatively large, a greater braking force is required to achieve the desired deceleration level of the elevator car. Therefore, the brake holding current is set lower so that it decays more quickly or the braking torque increases at a faster rate. Furthermore, in terms of the relationship between the travel direction of the elevator car and the brake holding current, when the elevator car is travelling upward, a smaller braking force is sufficient to achieve the desired deceleration level of the elevator car. Therefore, the brake holding current is set higher so that the braking torque increases at a slower rate. On the other hand, when the actual load is travelling downward, a greater braking force is required to achieve the desired deceleration level of the elevator car. Therefore, the brake holding current is set lower so that the braking torque increases at a faster rate.

The aforementioned actual load refers to the variable part of the total weight of the elevator car. In some cases, the actual load can be roughly understood as the weight of objects carried inside the elevator car (for example, passengers and cargo). However, in some other cases, it is advantageous to also take into account the weight of other objects associated with the elevator car. For example, in an elevator system, while the total length of the cable connected between the elevator car and the elevator control cabinet is fixed, the length of the suspended section (i.e., the length of the portion of the cable between the elevator car's cable bracket and the fixed point) varies with the position of the elevator car, and the weight of the suspended section is directly borne by the elevator car through the bracket, thereby constituting part of the actual load. The suspended portion of the cable is hereinafter referred to as the cable moving together with the elevator car or a trailing cable. For ultra-high-rise elevators, the impact of the trailing cable on the actual load cannot be ignored. For example, assuming that the linear density of a cable is 2.0 kg/m, when the length of a trailing cable is 100 meters, its weight will reach 200 kg, which is almost equivalent to the weight of objects carried inside the elevator car.

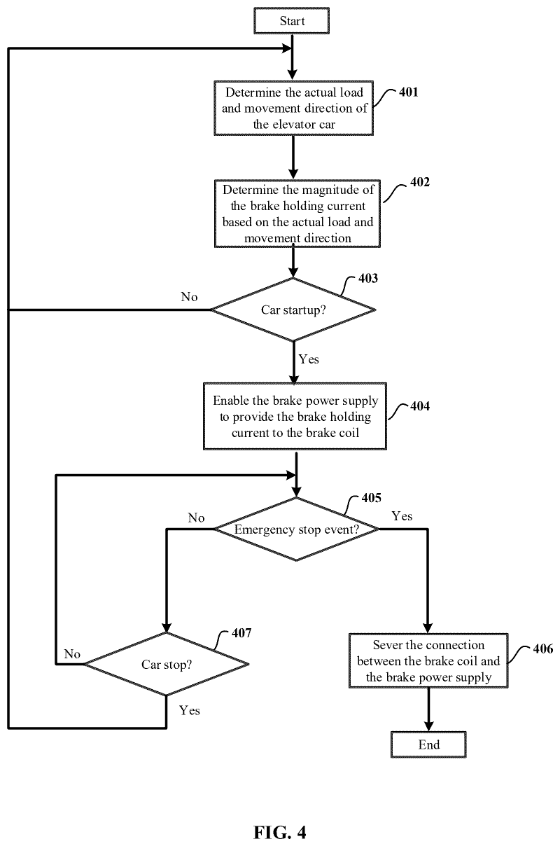

FIG. 4 shows a flowchart of a control method for elevator braking according to one embodiment of the present disclosure. The method described below can be implemented by various devices. These devices, for example, include but are not limited to an elevator controller (such as the controller 115 in FIG. 1), a safety controller and the like in the elevator system. These devices are hereinafter collectively referred to as an elevator brake control device or abbreviated as a control device.

The method illustrated in FIG. 4 starts from step 401. At this time, the elevator car is stationary. Therefore, no current flows through the brake coil, causing the brake device to be in the engaged state. In step 401, the control device will determine the actual load and travel direction of the elevator car. In this embodiment, assuming that the weight of other objects associated with the elevator car is negligible, the actual load is represented by the weight of objects carried inside the elevator car.

Optionally, the control device can obtain the weight of objects carried inside the elevator car from a weighting device of the elevator car, and determine the travel direction of the elevator car based on a dispatch command generated in response to an elevator call request.

Following step 401, the process illustrated in FIG. 4 proceeds to step 402. In this step, the control device determines the magnitude of the brake holding current based on the actual load and travel direction obtained from step 401. As noted above, for a relatively small actual load or an upward travel direction, a larger brake holding current can be set; for a relatively large actual load or a downward movement, a smaller brake holding current can be set. In some embodiments, the correspondence among the actual load of an elevator car, the travel direction, and the brake holding current can be predetermined through experiments (such as real-world simulation experiments or computer simulations). In step 402, this correspondence is used along with the actual load and travel direction obtained from step 401 to determine the magnitude of the brake holding current. For ease of access, the correspondence can be stored in the form of a two-dimensional table.

Then, the process proceeds to step 403. In this step, the control device determines whether the elevator car has started up or begins transitioning from a stationary state to a moving state. If it has started up, proceed to step 404; otherwise, return to step 401. In step 403, the control device can determine the startup of the elevator car by various means, for example, determine the state of the elevator car based on the elevator car speed (indirectly determined by the motor speed), leveling sensor signals (changes in the leveling sensor signals being triggered when the elevator car leaves the leveling zone), signal interlock conditions (for example, the door-closed relay contacts closing and the safety circuit being energized) and the like.

In step 404, under the control of the control device, the brake power supply provides the brake holding current whose magnitude is determined in step 402 to the brake coil. Take the device illustrated in FIG. 3 as an example. The control device can first cause a larger pick-up current to flow through the brake coil L by applying a PWM signal with a higher duty cycle to the control end of the switching element S. The current causes the brake shoes to be disengaged from the brake wheel. Then, by applying a PWM signal with a lower duty cycle to the control end, the brake holding current flows through the brake coil L, thereby maintaining the brake shoes and the brake wheel in the disengaged state.

Following step 404, the process illustrated in FIG. 4 proceeds to step 405. In this step, the control device determines whether an event triggering an emergency stop operation occurs. If such event occurs, proceed to step 406; otherwise, proceed to step 407. In step 405, exemplarily, the control device determines whether it is necessary to trigger an emergency stop operation based on connection or disconnection of an electrical safety circuit or signals of a safety sensor (such as a speed limiter switch, a safety gear action switch, a buffer switch, a pressure sensor, etc.).

In step 406, the control device will sever the connection between the brake coil and the brake power supply. Still take the device illustrated in FIG. 3 as an example. The control device causes the switching element S to be in a disconnected state by applying a disable signal to the control end of the switching element S, thereby severing the connection between the brake coil L and the brake power supply U. Since brake holding currents of varying magnitudes are determined based on the actual load and travel direction of the elevator car in step 402, after the connection between the brake coil and the brake power supply is severed, the brake holding currents will decay at an appropriate rate (i.e., the braking torque will increase at a different rate), thereby avoiding or mitigating too rapid deceleration of the elevator car.

Return to another branch step 407 of step 405. In this step, the control device determines whether the elevator car is in a stationary state (for example, it stops moving because it normally stops at a certain floor). If it is in a stationary state, the process returns to step 401 to determine the corresponding brake holding current for the next movement of the elevator car; otherwise, the process returns to step 405 to continue monitoring the occurrence of an emergency stop event. Similarly, the control device can determine the stationary state of the elevator car based on the elevator car speed, leveling sensor signals, signal interlock conditions and the like.

It should be noted that in this embodiment, the magnitude of the brake holding current is determined only prior to the startup of the elevator car, and it remains unchanged within a movement period from startup to stop of the elevator car.

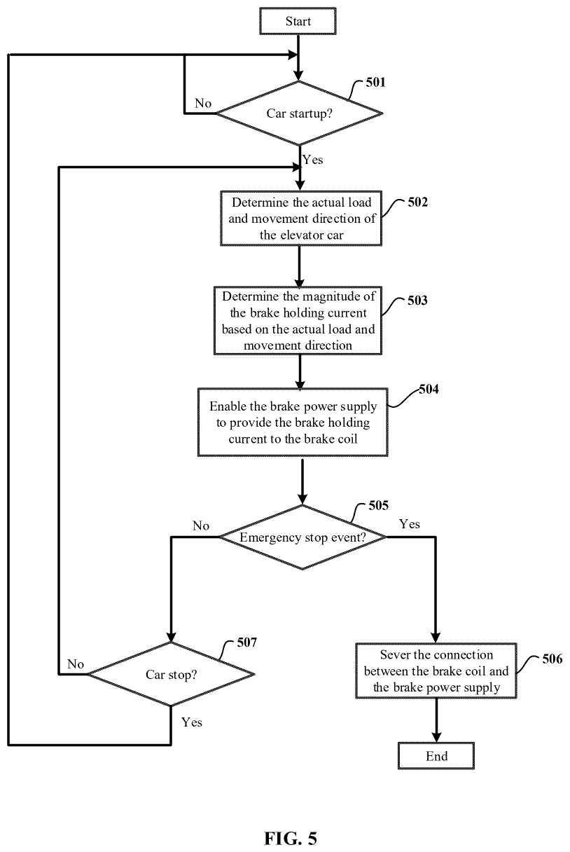

FIG. 5 shows a flowchart of a control method for elevator braking according to another embodiment of the present disclosure. The method described below can be implemented by various devices, which include, for example, but are not limited to, an elevator controller (such as the controller 115 in FIG. 1), a safety controller and the like in the elevator system.

The method illustrated in FIG. 5 starts from step 501. In this step, the control device determines whether the elevator car has started up or begins transitioning from a stationary state to a moving state. If it has started up, proceed to step 502; otherwise, continue to monitor the state of the elevator car.

In step 502, the control device will determine the actual load and travel direction of the elevator car. In this embodiment, apart from the weight of objects carried inside the elevator car, the actual load further comprises the weight of other objects associated with the elevator car, such as the weight of a trailing cable.

Optionally, the control device can obtain the weight of objects carried inside the elevator car from a weighting device of the elevator car, and determine the travel direction of the elevator car based on sensor signals (such as the phase difference between A-phase and B-phase pulses of an encoder, signal changes of a hoistway leveling sensor, directional signals of a counterweight-side encoder, and tension signals of a wire rope tension sensor etc.). Furthermore, the weight of the trailing cable can be determined based on the position of the elevator car. Take the trailing cable with both ends respectively fixed to the bottom of the hoistway and the elevator car as an example. Its length varies linearly with the height of the elevator car relative to the bottom of the hoistway. Therefore, the length of the trailing cable can be represented by the height of the elevator car. Exemplarily, the control device can determine the position of the elevator car based on the position signals provided by a position reference device (such as the position reference system 113 or any other desirable position reference device in FIG. 1).

Further optionally, the actual load can be determined based on the working current or torque of a drive motor (such as the motor comprised in the unit 111 in FIG. 3). For example, the torque T output by the motor can be directly measured using a torque sensor, and the weight of the elevator car can be determined based on the following exemplary relational expression:

m=m_{counterweight}+t×η×I/(g×r) (1)

wherein η represents the transmission efficiency of an elevator system; m and m_{counterweight} represent the total weight (including dead weight and actual load) and the counterweight of an elevator car, respectively; g represents gravitational acceleration; r represents the radius of a traction sheave; and I represent the working current of a drive motor.

In addition, the actual load of the elevator car can be obtained based on the elevator car weight m determined according to the above expression.

Following step 502, the process illustrated in FIG. 5 proceeds to step 503. In this step, the control device determines the magnitude of the brake holding current based on the actual load and travel direction obtained from step 502. The specific way of determining the brake holding current has been described in detail above, which will not be repeated here.

The process then proceeds to step 504. In this step, under the control of the control device, the brake power supply provides the brake holding current whose magnitude is determined in step 503 to the brake coil. Exemplarily, the control device can first cause a larger pick-up current to flow through the brake coil L so that the brake shoes are disengaged from the brake wheel, and then cause the brake holding current to flow through the brake coil L, thereby maintaining the brake shoes and the brake wheel in the disengaged state.

Following step 504, the process illustrated in FIG. 5 proceeds to step 505. In this step, the control device determines whether an event triggering an emergency stop operation occurs. If such event occurs, proceed to step 506; otherwise, proceed to step 507.

In step 506, the control device will sever the connection between the brake coil and the brake power supply. Exemplarily, the control device causes the switching element S to be in a disconnected state by applying a disable signal to the control end of the switching element S. Since brake holding currents of varying magnitudes are determined based on the actual load and travel direction of the elevator car in step 503, after the connection between the brake coil and the brake power supply is severed, the brake holding currents will decay at an appropriate rate, thereby avoiding or mitigating too rapid deceleration of the elevator car.

In another branch step 507 of step 505, the control device determines whether the elevator car is in a stationary state (for example, it stops moving because it normally stops at a certain floor). If it is in a stationary state, the process returns to step 501; otherwise, the process returns to step 502 to continue performing steps 502 to 504. In this embodiment, steps 502 to 504 may be performed multiple times within a movement period from startup to stop of the elevator car. As the actual load and travel direction of the elevator car will be determined every time step 502 is performed, the brake holding current will be updated in real time within a movement period from startup to stop of the elevator car to match the dynamically changing actual load.

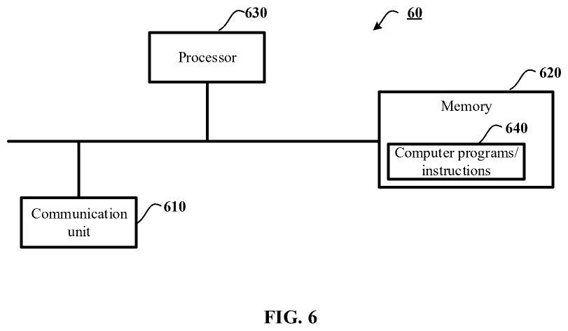

FIG. 6 shows a schematic block diagram of an elevator brake control device according to yet another embodiment of the present disclosure. The control device illustrated in FIG. 6 can be used, for example, to implement an elevator controller (such as the controller 115 in FIG. 1) or a safety controller and the like in the elevator system.

As illustrated in FIG. 6, the control device 60 comprises a communication unit 610, one or more memories 620 (for example, non-volatile memories such as a flash memory, ROM, hard disk drive, magnetic disk, optical disk, etc.), one or more processors 630, and computer programs/instructions 640.

The communication unit 610 serves as a communication interface, and is configured to receive control commands and data from an external device (for example, other units in the elevator system (such as the unit 111 and the position reference system 113 in FIG. 1) or network (such as internet, wireless local area network, and the like), and send the control commands and data generated at the control device 60 to the external device or network.

The memory 620 stores computer programs/instructions 640 executable by the processor 630. In addition, the memory 620 may also store the data generated by the processor 630 when executing the computer programs/instructions 640, the configuration data that needs to be invoked (such as the correspondence among the actual load of an elevator car, the travel direction, and the brake holding current), and the data (such as the movement speed and position of the elevator car, status signals of the safety chains, and the like) received from the external device via the communication unit 610.

The processor 630 is configured to execute the computer programs/instructions 640 stored on the memory 620 and perform access operations on the memory 620.

The computer programs/instructions 640 may include program codes for implementing the various functions and operations described in FIGS. 2 to 5, so that these functions and operations can be implemented by executing the computer programs/instructions 640 on the processor 630.

Various embodiments of the system and technology described herein may be implemented in a digital electronic circuit system, an integrated circuit system, a field programmable gate array (FPGA), an application-specific integrated circuit (ASIC), an application-specific standard product (ASSP), a system on a chip (SOC), a complex programmable logic device (CPLD), a computer hardware, a firmware, a software, and/or combinations thereof. These various embodiments may include: implementation in one or more computer programs. The one or more computer programs can be executed and/or interpreted on a programmable system including at least one programmable processor. The programmable processor may be a dedicated or general-purpose programmable processor, which may receive data and instructions from a storage system, at least one input device and at least one output device, and transmit the data and instructions to the storage system, the at least one input device and the at least one output device.

The program codes for implementing the method of the present disclosure may be written in one programming language or any combination of more than one programming languages. These program codes may be provided to a processor or controller of a general-purpose computer, a dedicated computer, or other programmable data processing device, so that the program codes, when executed by the processor or controller, cause the functions/operations specified in the flow diagram and/or block diagram to be implemented. The program codes may be executed entirely on a machine or partly on a machine, or may serve as an independent software package to be executed partly on a machine and partly on a remote machine, or entirely on a remote machine or a server.

To demonstrate interchangeability between hardware and software, various illustrative components, blocks, modules, circuits and steps have been described above in general terms based on their functionality. Such functionality is implemented in the form of hardware or software, depending on particular applications and design constraints imposed on the overall system. A person skilled in the art may implement the described functionality in varying ways for particular applications, but such implementation decisions should not be construed to result in a departure from the scope of the present disclosure.

While only some embodiments of the present disclosure are described, it should be understood by a person skilled in the art that the present disclosure can be implemented in various other forms without departing from its main purpose and scope. Therefore, the examples and embodiments provided are intended to be illustrative rather than restrictive, and the present disclosure may encompass various modifications and substitutions without departing from the spirit and scope of the present disclosure as defined in the appended claims.

What is claimed is:

1. A control method for elevator braking, comprising:
A. determining a brake holding current based on an actual load and a travel direction of an elevator car, wherein the brake holding current is determined to be larger for the actual load being smaller or the travel direction being upward, and smaller for the actual load being larger or the travel direction being downward;
B. enabling a brake power supply to provide the brake holding current as determined to a brake coil; and
C. in response to an event triggering an emergency stop operation, disconnecting the brake coil from the brake power supply.

2. The control method according to claim 1, wherein the actual load comprises a weight of objects carried inside the elevator car.

3. The control method according to claim 2, wherein the weight of objects carried inside the elevator car is provided by a weighting device of the elevator car.

4. The control method according to claim 2, wherein step A is performed prior to startup of the elevator car, and the brake holding current remains unchanged within a movement period from the startup to stop of the elevator car.

5. The control method according to claim 1, wherein the actual load comprises the weight of objects carried inside the elevator car and a weight of a cable moving together with the elevator car.

6. The control method according to claim 5, wherein the weight of objects carried inside the elevator car is provided by a weighting device of the elevator car, and the weight of the cable moving together with the elevator car is determined based on a position of the elevator car in a hoistway.

7. The control method according to claim 5, wherein step A is performed periodically or non-periodically within a movement period from startup to stop of the elevator car.

8. The control method according to claim 1, wherein in step A, the brake holding current is determined based on a predetermined correspondence among the actual load of the elevator car, the travel direction, and the brake holding current, wherein the correspondence is obtained through theoretical calculations or experiments.

9. The control method according to claim 1, wherein the actual load is determined based on a working current of a drive motor.

10. The control method according to claim 1, wherein in step B, the brake holding current as determined is provided to the brake coil by controlling a duty cycle of a control signal applied to a switching element, wherein the switching element is connected between the brake coil and the brake power supply.

11. An elevator brake control device, comprising:
at least one processor;
at least one memory; and
computer programs/instructions stored on the memory, when executed on the processor, causing the following operations
A. determining a brake holding current based on an actual load and a travel direction of an elevator car, wherein the brake holding current is determined to be larger for the actual load being smaller or the travel direction being upward, and smaller for the actual load being larger or the travel direction being downward;
B. enabling a brake power supply to provide the brake holding current as determined to a brake coil; and
C. in response to an event triggering an emergency stop operation, disconnecting the brake coil from the brake power supply.

12. The control device according to claim 11, wherein the actual load comprises a weight of objects carried inside the elevator car.

13. The control device according to claim 12, wherein the execution of the computer programs/instructions on the processor causes the weight of objects carried inside the elevator car to be obtained from a weighing device of the elevator car.

14. The control device according to claim 12, wherein the execution of the computer programs/instructions on the processor causes operation A to be performed prior to startup of the elevator car, and the brake holding current to remain unchanged within a movement period from the startup to stop of the elevator car.

15. The control device according to claim 11, wherein the actual load comprises a weight of objects carried inside the elevator car and a weight of a cable moving together with the elevator car.

16. The control device according to claim 15, wherein the execution of the computer programs/instructions causes the weight of objects carried inside the elevator car to be obtained from a weighing device of the elevator car, and the weight of the cable moving together with the elevator car to be determined based on a position of the elevator car in a hoistway.

17. The control device according to claim 15, wherein the execution of the computer programs/instructions causes operation A to be performed periodically or non-periodically within a movement period from startup to stop of the elevator car.

18. The control device according to claim 11, wherein the execution of the computer programs/instructions causes operation A to be performed in the following manner: determining the brake holding current based on a predetermined correspondence among the actual load of an elevator car, the travel direction, and the brake holding current, wherein the correspondence is obtained through theoretical calculations or experiments.

19. The control device according to claim 11, wherein the execution of the computer programs/instructions causes the actual load to be determined based on a working current of a drive motor.

20. The control device according to claim 11, wherein the execution of the computer programs/instructions causes operation B to be performed in the following manner: providing the brake holding current as determined to a brake coil by controlling a duty cycle of a control signal applied to a switching element, wherein the switching element is connected between the brake coil and the brake power supply.

21. The control device according to claim 11, wherein the control device is an elevator controller or a safety controller.

22. A non-transitory computer-readable storage medium with computer programs/instructions stored thereon, wherein the computer programs/instructions are executed by a processor to perform the steps of the method according to claim 1.
